(19) United States
(12) Patent Application Publication
(10) Pub. No.: US 2019/0339004 A1
(43) Pub. Date: Nov. 7, 2019

(54) Domestic cooling device having a wall light

(71) Applicant: emz-Hanauer GmbH & Co. KGaA, Nabburg (DE)

(72) Inventors: Manfredi Signorino, Wackersdorf (DE); Martin Brabec, Nabburg (DE); Franz Forster, Altfalter (DE)

(73) Assignee: emz-Hanauer GmbH & Co. KGaA, Nabburg (DE)

(21) Appl. No.: 16/396,848

(22) Filed: Apr. 29, 2019

(30) Foreign Application Priority Data
May 3, 2018 (DE) 102018003584.1

(51) Int. Cl. F25D 27/00; F21V 7/00; F21V 3/00

(52) U.S. Cl. CPC F25D 27/00; F21Y 2115/10; F21V 3/00; F21V 7/0016

(57) ABSTRACT

A domestic cooling device has a cold chamber and a wall light arranged on a delimiting wall of the cold chamber for illuminating the cold chamber. The wall light includes at least one light source and a window region manufactured from a transparent material, through which the light generated by the wall light emerges into the cold chamber. There is a reflection surface, in particular having a diffusely reflecting action, which is arranged in front of the window region in the propagation path of at least a portion of the light radiation coming from the light source. At least a portion of the reflection surface is formed by the delimiting wall, in particular by an inner lining part of the cooling device. The reflection surface can be formed in a hollow in the inner lining part. The window region extends over at least a portion of the hollow.

### BACKGROUND OF THE INVENTION

### 1. Field of the Invention

The present invention relates generally to a domestic cooling device which is equipped with a wall light for illuminating a cold chamber of the domestic cooling device.

### 2. Description of the Prior Art

Domestic refrigerators are typically provided with one or more lights, the purpose of which is to light a cold chamber of the refrigerator when the refrigerator door is open, so that the user has a better view of the foods stored in the cold chamber. A type of light that is conventionally used is a wall light, which is mounted on a delimiting wall of the cold chamber.

### SUMMARY OF THE INVENTION

An object of the invention is to show a way in which, in a domestic cooling device, a wall light can be produced in a structurally simple manner and with low production costs.

In order to achieve that object there is provided a domestic cooling device having a cold chamber and a wall light arranged on a delimiting wall of the cold chamber for illuminating the cold chamber, wherein the wall light comprises at least one light source, in particular of the LED type, and a window region manufactured from a transparent material, through which the light generated by the wall light emerges into the cold chamber, wherein there is associated with the wall light a reflection surface, in particular having a diffusely reflecting action, which is arranged in front of the window region in the propagation path of at least a portion of the light radiation coming from the light source. According to the invention, such a domestic cooling device is characterised in that at least a portion of the reflection surface is formed by the delimiting wall. In particular, the reflection surface can be formed wholly by the delimiting wall of the cold chamber.

The invention is based on the idea that, in order to produce the reflection surface, it is not necessary to provide a reflector body which is separate from the delimiting wall. Instead, the delimiting wall itself can serve as the (in particular scattering) reflector. This is the case in particular when the delimiting wall comprises an inner lining part, adjoining the cold chamber, which is suitably matt on its surface facing the cold chamber and accordingly diffusely reflects, that is to say scatters, light radiation which is emitted from the at least one light source of the wall light in the direction towards the inner lining part. Domestic refrigerators are conventionally designed with an inner lining which is manufactured from a thermoplastic plastics material and which delimits, between itself and an outer lining, a cavity filled with a heat-insulating foam. The invention allows the inner lining, that is to say a part-region thereof, to be used as the reflector for at least a portion of the light radiation emitted by the at least one light source. Since the inner lining is provided in any case, the required outlay in terms of additional components for producing the wall light can be kept low, which has an advantageous effect on the production costs of the wall light.

In particular embodiments, at least a portion of the reflection surface is formed in a hollow of the delimiting wall, wherein the window region extends over at least a portion of the hollow. It is already known in the prior art, in a deep-drawing operation in which an inner lining part is formed from a piece of sheet of thermoplastic plastics material, to form in the piece of sheet one or more depressions which can be used to receive fixing screws or other components in a recessed manner, see EP 2 333 465 A2. In such a deep-drawing operation, a hollow can also be formed in the inner lining part in a simple manner, the hollow surface of which hollow serves as the reflection surface of the wall light.

In particular embodiments, the light source is arranged so that it is recessed in the hollow. The wall light can comprise a plurality of light sources arranged in a row spaced apart one behind the other, and a circuit board on which the light sources are mounted. In order that the wall light protrudes only slightly from the delimiting wall, it is advantageous if the circuit board is arranged so that it is recessed at least in part, in particular substantially completely, in the hollow.

In particular embodiments, the hollow is in the form of a groove, wherein, when viewed in the groove cross-section, it has two opposite flank regions of different flank steepness. The light source can be arranged closer to the steeper of the two flank regions. If a plurality of light sources are present, they are arranged in a row spaced apart one behind the other in the longitudinal direction of the groove.

In particular embodiments, the light source and the window region are combined in a preassembled assembly which can be attached as such to the delimiting wall. For this purpose, at least one mounting opening can be formed in the delimiting wall, wherein the preassembled assembly has, in association with each mounting opening, in each case at least one mounting member which engages in the mounting opening in question.

In particular embodiments, the wall light has a frame region which extends all round the window region and has a visible surface, facing towards the cold chamber, which contrasts visually with the window region. Although it is possible in principle within the context of the invention to use separate components for the frame region and the window region, for example a frame body into which a separate window element is inserted, it is provided in particular embodiments that the window region and the frame region are formed integrally in one piece. The frame region can thereby be formed of a different-coloured material to the window region. Alternatively or in addition, the visible surface can have a different surface condition to the window region. For example, the frame region and the window region can be manufactured from the same transparent plastics material, wherein the resulting plastics body is surface-treated, for example roughened, in the region of the visible surface in order to reduce or even completely eliminate the transparency in the region of the visible surface.

The invention will be explained further hereinbelow with reference to the accompanying drawings.

### BRIEF DESCRIPTION OF THE DRAWINGS

FIG. 1 shows, schematically, a domestic cooling device according to an exemplary embodiment.

FIG. 2 shows components for forming a wall light of the domestic cooling device of FIG. 1 before final mounting of the wall light.

FIG. 3 shows the wall light of FIG. 2 in the final mounted state.

### DETAILED DESCRIPTION OF THE INVENTION

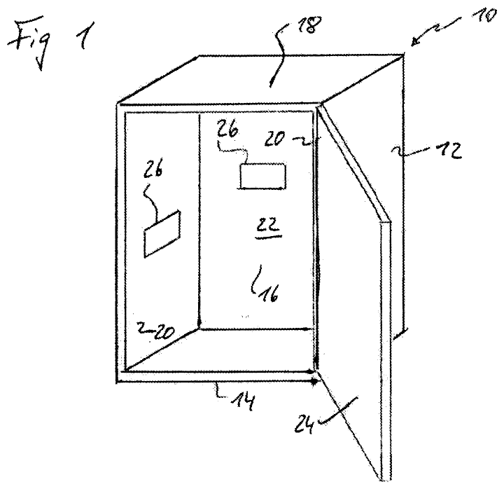

Reference will first be made to FIG. 1. The cooling device shown therein, which is intended for use in a private household, is designated generally 10. The cooling device 10 serves for keeping foods cold above or/and below the freezing point. In the example shown, it is in the form of a cabinet and comprises a main housing 12 having a bottom wall 14, a rear wall 16, a top wall 18 and two mutually opposite side walls 20, which together delimit an interior 22 of the cooling device 10. The interior 22 forms the cold chamber for storing the foods to be kept in the cooling device 10. A door 24 by means of which the interior (cold chamber) 22 can be closed in the conventional manner is pivotably mounted on the main housing 12.

When the door 24 is open (shown in FIG. 1), it is desirable to illuminate the interior 22 artificially, in order to provide the user with a better view of the foods therein. For this purpose, at least one wall light 26 is arranged on at least one of the walls 14, 16, 18, 20, which wall light is so controlled that it is switched on and off depending on the opening and closing of the door 24. In the example shown, one wall light 26 is arranged on the rear wall 16 and a further wall light 26 is arranged on the side wall 20 on the left in the representation of FIG. 1. It will be appreciated that the distribution pattern of the wall lights 26 shown in FIG. 1 is purely by way of example and can be changed as desired in terms of both the number and the position of the wall lights 26. It will additionally be appreciated that the wall lights 26 do not have to be the only lighting means with which the cooling device 10 is equipped. In addition to the wall lights 26, lighting means of different forms can be provided. Such different types of lighting means are not subject-matter of the present disclosure and require no further explanation.

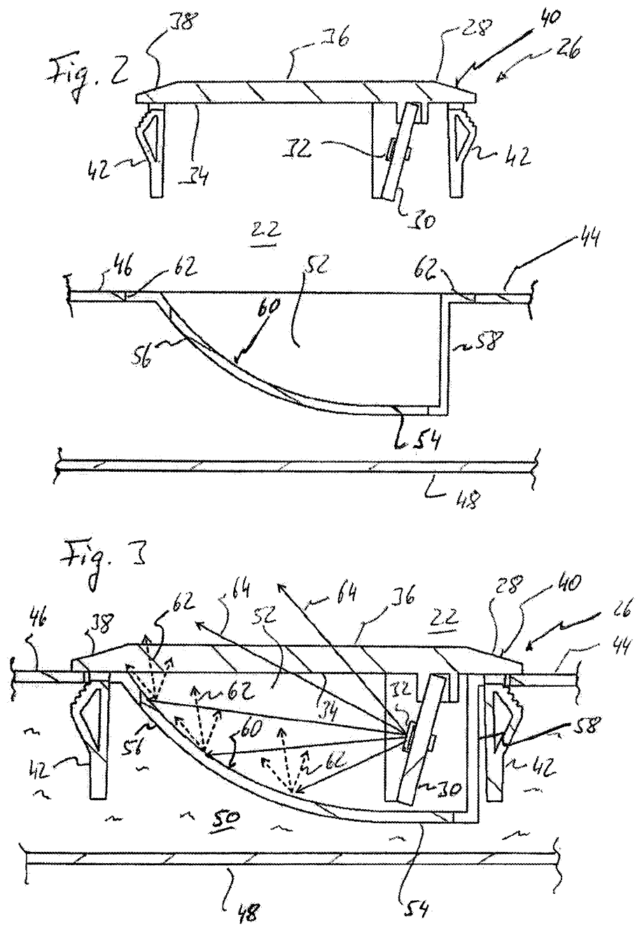

For further details of the wall lights 26, reference will now additionally be made to FIGS. 2 and 3, which are sectional representations of one of the wall lights 26, on the one hand before final mounting (FIG. 2) and on the other hand in the final mounted state (FIG. 3). According to the exemplary embodiment of FIGS. 2 and 3, the wall light 26 comprises a light subassembly 28 which can be preassembled, which is also referred to hereinbelow as a lighting module. The lighting module 28 comprises a plurality of light sources 32 (e.g. white-light LEDs) arranged in a row spaced apart one behind the other on a circuit board 30, and a module body 34 to which the circuit board 30 is releasably or permanently fixed, for example by a snap-action connection or a press-fit connection. The row of light sources 32 extends perpendicularly to the plane of the drawing of FIGS. 2 and 3. The module body 34 forms a plate- or disc-like window region 36 and a frame region 38 which surrounds the window region 36 all round and in which the module body 34 forms a visible surface 40 which contrasts visually with the window region 36.

The module body 34 can be a one-piece component which is permeable in the window region 36 to light in the visible range so that light generated by the light sources 32 can pass through the wall light 26 through the window region 36. In the window region 36, the module body 34 can be in the form of, for example, a transparent body with a transmission of 90% or 95% or more for visible light. Alternatively, the module body 34 can have a milky (opaque) appearance in the window region 36.

In the frame region 38, the module body 34 can consist of the same material as in the window region 36, whereby, in order to achieve the desired visual contrast between the visible surface 40 and the window region 36, the visible surface 40 can have been subjected to a surface treatment. The surface treatment can comprise, for example, a coating with a coloured lacquer or with a coating having a metallic appearance (galvanisation). Alternatively, the frame region 38 can have been subjected to roughening of its surface in the region of the visible surface 40 so that the transparency in that region is reduced or even eliminated completely as compared with the window region 36.

Another possibility consists in producing the module body 34 from plastics materials of different kinds in a multi-component injection-moulding process, a transparent plastics material being used for the window region 36 and a non-transparent plastics material being used for the frame region 38 and any other regions of the module body 34.

As an alternative to a one-piece form of the module body 34 it is additionally possible to design the module body 34 in multi-part form. A first part-body can thereby be formed by a separate window element which forms the window region 36. A second part-body can be formed by a frame element which forms the frame region 38. The frame element can provide a recess having a support surface for the window element, the window element being inserted into the recess and fixedly connected to the frame element by adhesive bonding or welding, for example.

In the example shown, the module body 34 additionally comprises a plurality of clamping projections 42, for example in tab or tongue form, serving as mounting members, which clamping projections serve for mounting the lighting module 28 on a delimiting wall 44. The delimiting wall 44 is one of the walls which delimit the interior 22 of the cooling device 10 of FIG. 1. For example, the delimiting wall 44 is the rear wall 16 or one of the side walls 20.

The delimiting wall 44 is of multi-layer construction and comprises an inner lining part 46, an outer lining part 48, and a heat-insulating foam material 50 which fills a cavity between the inner lining part 46 and the outer lining part 48 (FIG. 3). The inner lining part 46 is manufactured from thermoplastic plastics material and can be produced in a deep-drawing operation from a preliminary product in sheet form. A hollow 52 is formed into the inner lining part 46, which hollow, in the example shown, is in the form of a groove-like depression which, in the groove cross-section (according to the representation of FIGS. 2 and 3), has a groove bottom 54 and two groove flanks 56, 58 laterally adjoining the groove bottom 54. It will be seen that one of the groove flanks (here the groove flank 58) is considerably steeper than the other groove flank (here the groove flank 56). Specifically, in the example shown in FIGS. 2 and 3, the steeper groove flank 58 extends substantially perpendicularly to the wall plane of the delimiting wall 44 while the groove flank 56 follows a path which is curved in an arcuate manner. The row of light sources 32 extends in the groove longitudinal direction of the hollow 52, the light sources being arranged closer to the steeper of the groove flanks (here the groove flank 58) than to the other groove flank.

In the region of the groove bottom 54 and the less steep groove flank 56, the surface of the inner lining part 46 facing towards the interior 22 of the cooling device 10 forms a reflection surface 60 which is situated inside the hollow 52 and at which incident light generated by the light sources 32 undergoes diffuse reflection (scattering). In FIG. 3, the resulting scattered radiation is illustrated graphically by broken arrows 62. The scattering action of the inner lining part 46 in the region of the reflection surface 60 is achieved, for example, by a suitably matt form of the surface of the inner lining part 46 that faces the cold chamber. Alternatively or in addition, it is conceivable to provide the inner lining part 46 with a suitable surface roughness at least in the region of the reflection surface 60.

Mounting openings 62 are introduced into the inner lining part 46, in which mounting openings the clamping projections 42 are received when the lighting module 28 is fitted to the inner lining part 46. The clamping projections 42 are resiliently deflectable and brace the lighting module 28 relative to the inner lining part 46.

FIG. 3 shows the final mounted state, after the lighting module 28 has been mounted on the inner lining part 46. The circuit board 30 is so oriented that a portion of the light radiation emitted by the light sources 32 first strikes the reflection surface 60, where it is scattered. Only then does the resulting scattered radiation (represented by the arrows 62) leave the wall light 26 through the window region 36. Another portion of the light radiation emitted by the light sources 32 strikes the window region 36 directly, as is illustrated in FIG. 3 by two solid arrows 64. This portion of the light radiation, depending on the angle of incidence, can leave the wall light 26 directly through the window region 36, or it may undergo total reflection at the side of the window region 36 that is remote from the cold chamber and be reflected back in the direction towards the reflection surface 60, where it is scattered.

Because the reflection surface 60 is provided directly on the inner lining part 46, the wall light 26 does not require a separate reflector body, which would have to be produced in addition to the inner lining part 46. This lowers the outlay for the wall light 26 in terms of components and reduces the production costs thereof.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A domestic cooling device comprising:
a cold chamber; and
a wall light arranged on a delimiting wall of the cold chamber for illuminating the cold chamber,
wherein the wall light comprises at least one light source and a window region manufactured from a transparent material, through which the light generated by the wall light emerges into the cold chamber, wherein there is associated with the wall light a reflection surface, in particular having a diffusely reflecting action, which is arranged in front of the window region in the propagation path of at least a portion of the light radiation coming from the light source, characterised in that at least a portion of the reflection surface is formed by the delimiting wall.

2. The domestic cooling device according to claim 1, wherein at least a portion of the reflection surface is formed in a hollow of the delimiting wall, and the window region extends over at least a portion of the hollow.

3. The domestic cooling device according to claim 2, wherein the hollow is formed in an inner lining part manufactured in particular from a plastics material, behind which there is arranged a heat-insulating material introduced between the inner lining part and an outer lining part.

4. The domestic cooling device according to claim 2, wherein the light source is arranged so that it is recessed in the hollow.

5. The domestic cooling device according to claim 2, wherein the wall light comprises a plurality of light sources arranged in a row spaced apart one behind the other, and a circuit board on which the light sources are mounted, wherein the circuit board is arranged so that it is recessed at least in part in the hollow.

6. The domestic cooling device according to claim 2, wherein the hollow is in the form of a groove and, when viewed in the groove cross-section, has two opposite flank regions of different flank steepness, wherein the light source is arranged closer to the steeper of the two flank regions.

7. The domestic cooling device according to claim 1, wherein the light source and the window region are combined in a preassembled assembly which can be attached as such to the delimiting wall.

8. The domestic cooling device according to claim 7, wherein at least one mounting opening is formed in the delimiting wall and the preassembled assembly has, in association with the at least one mounting opening, at least one mounting member which engages in the at least one mounting opening.

9. The domestic cooling device according to claim 1, wherein the wall light has a frame region which extends all around the window region and has a visible surface, facing towards the cold chamber, which contrasts visually with the window region.

10. The domestic cooling device according to claim 9, wherein the window region and the frame region are formed integrally in one piece, wherein at least one of the following applies:
the frame region is formed of a different-coloured material to the window region; and
the visible surface has a different surface condition to the window region.

11. The domestic cooling device according to claim 1, wherein the at least one light source is an LED.

12. The domestic cooling device according to claim 3, wherein the heat-insulating material is a foam material.

13. The domestic cooling device according to claim 2, wherein the wall light comprises a plurality of light sources arranged in a row spaced apart one behind the other, and a circuit board on which the light sources are mounted, wherein the circuit board is arranged so that it is recessed substantially completely in the hollow.
